(19) United States
(12) Patent Application Publication
(10) Pub. No.: US 2012/0314070 A1
(43) Pub. Date: Dec. 13, 2012

(54) LANE SENSING ENHANCEMENT THROUGH OBJECT VEHICLE INFORMATION FOR LANE CENTERING/KEEPING

(75) Inventors: Wende Zhang, Troy, MI (US); Bakhtiar Brian Litkouhi, Washington, MI (US); Jin-Woo Lee, Rochester Hills, MI (US)

(73) Assignee: GM GLOBAL TECHNOLOGY OPERATIONS LLC, Detroit, MI (US)

(21) Appl. No.: 13/157,124

(22) Filed: Jun. 9, 2011

(51) Int. Cl. H04N 7/18; G06K 9/60

(52) U.S. Cl. 348/148; 382/190; 348/E07.085

(57) ABSTRACT

A system and method for accurately estimating a lane in which a vehicle is traveling. A sensor mounted on the vehicle generates sensor data including lane information that is processed by several lane detection sub-systems to generate two or more estimated lanes with corresponding lane confidence information. A combining processor combines the estimated lanes based upon the confidence information to determine a combined estimated lane.

### BACKGROUND OF THE INVENTION

1. Field of the Invention

This invention relates generally to a system and method for detecting a roadway lane in which vehicles are traveling and, more particularly, to a system and method for detecting a roadway lane in which a vehicle is traveling that includes processing sensor data in various ways to estimate the lane and identifying corresponding confidence information, then combining the various estimated lanes using the confidence information to detect the roadway lane.

2. Discussion of the Related Art

Modern vehicles are becoming more autonomous, i.e., vehicles are able to provide driving control with less driver intervention. Cruise control systems have been on vehicles for a number of years where the vehicle operator can set a particular speed of the vehicle, and the vehicle will maintain that speed without the driver operating the throttle. Adaptive cruise control systems have been recently developed in the art where not only does the system maintain the set speed, but also will automatically slow the vehicle down in the event that a slower moving vehicle is detected in front of the subject vehicle using various sensors, such as radar and cameras. Modern vehicle control systems may also include autonomous parking where the vehicle will automatically provide the steering control for parking the vehicle, and where the control system will intervene if the driver makes harsh steering changes that may affect vehicle stability and lane centering capabilities, where the vehicle system attempts to maintain the vehicle near the center of the lane. Fully autonomous vehicles have been demonstrated that drive in simulated urban traffic up to 30 mph such as DARPA Urban Challenge in 2007, while observing all of the rules of the road.

As vehicle systems improve, they will become more autonomous with the goal being a completely autonomously driven vehicle. Future vehicles will likely employ autonomous systems for lane changing, passing, turns away from traffic, turns into traffic, etc. As these systems become more prevalent in vehicle technology, it will also be necessary to determine what the driver's role will be in combination with these systems for controlling vehicle speed, steering and overriding the autonomous system.

Examples of semi-autonomous vehicle control systems include U.S. patent application Ser. No. 12/399,317 (herein referred to as '317), filed Mar. 6, 2009, titled “Model Based Predictive Control for Automated Lane Centering/Changing Control Systems,” assigned to the assignee of this application and herein incorporated by reference, which discloses a system and method for providing steering angle control for lane centering and lane changing purposes in an autonomous or semi-autonomous vehicle. U.S. patent application Ser. No. 12/336,819, filed Dec. 17, 2008, titled “Detection of Driver Intervention During a Torque Overlay Operation in an Electric Power Steering System,” assigned to the assignee of this application and herein incorporated by reference, discloses a system and method for controlling vehicle steering by detecting a driver intervention in a torque overlay operation.

Current vehicle lane centering/keeping systems typically use vision systems to sense a lane and drive the vehicle in the lane-center. Several methods employ digital cameras to detect lanes. Research has shown that lane centering/keeping systems that detect other vehicles can improve the accuracy of the lane estimate. Depending on the driving situation, different lane detection methods may fail. For example, when a leading-vehicle comes too close to the subject vehicle, due to traffic congestion or other traffic situations, the cameras may not detect lane-markers because the markers are hidden by the leading-vehicle, and thus, lane-marker detection of the lane will fail. Likewise, other techniques that have proven useful, such as following a leading-vehicle, will fail if there is no leading-vehicle to follow on an empty road, or the leading-vehicle is performing a lane change.

A need exists for a lane centering system and method that works in various real-life situations and constantly detects the lane even when a single method of estimating the lane geometry fails or produces poor lane estimates.

### SUMMARY OF THE INVENTION

In accordance with the teachings of the present invention, a system and method are disclosed for detecting a roadway lane in which a vehicle is traveling. A sensor mounted on the vehicle generates data including lane information that is processed to generate two or more estimated lanes with corresponding lane confidence information. A combining processor combines the estimated lanes based on the confidence information to determine an combined estimated lane. The combining processor can also adjust the vehicle so that the next estimated lanes have more accuracy or a higher confidence.

Additional features of the present invention will become apparent from the following description and appended claims, taken in conjunction with the accompanying drawings.

### BRIEF DESCRIPTION OF THE DRAWINGS

FIG. 1 is a diagram of a vehicle including a lane centering system for centering the vehicle in a roadway lane in which the vehicle is traveling;

FIG. 2 is a block diagram of a lane estimating sub-system that can be part of the lane centering system shown in FIG. 1;

FIG. 3 is a block diagram of a leading-vehicle lane processor; and

FIG. 4 is an illustration showing when a lane estimated by a leading-vehicle tracking method is needed to provide a detected lane because the leading-vehicle hides the lane-markers.

### DETAILED DESCRIPTION OF THE EMBODIMENTS

The following discussion of the embodiments of the invention directed to a system and method for detecting a vehicle roadway lane in which a vehicle is traveling is merely exemplary in nature, and is in no way intended to limit the invention or its applications or uses.

The present invention proposes a system and method for accurately detecting a vehicle travel lane, where the vehicle includes sensors that provide sensor data including lane information to a lane detection sub-system. The lane detection sub-system provides estimated lanes and corresponding confidence information. For example, the estimated lane processors could detect the lane based on lane-markers, a leading-vehicle or lane level accurate GPS/Maps. The estimated lanes and corresponding confidence information is combined to give a detected lane, as well as be used to adjust the vehicle to improve the accuracy of the next estimated lanes and confidence information.

FIG. 1 is a diagram of a vehicle 10 including a lane centering system 14 for centering the vehicle 10 in a roadway lane in which the vehicle 10 is traveling. The vehicle 10 includes a camera 12 mounted to the vehicle 10 that provides sensor data, in this case images of the lane, to the lane centering system 14. In other embodiments, the vehicle 10 may employ multiple cameras including rearward facing cameras. The vehicle 10 includes a vehicle-to-vehicle (V2V) communication system 16 that provides sensor data concerning information received from nearby vehicles including vehicle positions and whether a leading-vehicle is changing lanes. The vehicle 10 also includes a global positioning system (GPS) and map system 18 that combines GPS sensor data with a computerized map to provide information about the lane ahead of the vehicle 10 to the lane centering system 14. The lane centering system 14 processes sensor data several ways to arrive at several estimated lanes. One embodiment estimates the lane though a lane-marker processor, a leading-vehicle processor and a GPS/Map processor. Along with the estimated lane information, information about the confidence in the estimated lane is provided that tells how reliable or accurate the estimated lane is. For example, if the estimated lane is based on leading-vehicle tracking methods, whether the leading-vehicle is changing lanes would be part of the confidence information. The lane centering system 14 considers the estimated lanes and confidence information along with additional vehicle/road information to determine a detected lane. The lane centering system 14 commands a steering system 20 to position the vehicle 10 in the desired lane-center of the detected lane based on the estimated lane.

Although this discussion describes calculating a detected lane and positioning the vehicle 10 in the lane-center, the term ‘lane-center’ indicates the desired position in the lane—which often is the geometric lane center. However, lane-center can mean any desired position in the roadway lane. Particularly, the lane-center can be the geometric lane center, an offset from the geometric lane center, or some other desired position in the lane, such as the left edge of the lane when passing a police car that is on the right shoulder or 10 to 50 cm offset from the lane-center due to habit or because of a nearby guardrail.

Although the discussion herein describes a leading-vehicle as being in the same lane as the vehicle 10 and positioned ahead of the vehicle 10, the term ‘leading-vehicle’ can refer to not only another vehicle that is ahead of the vehicle 10, but also a vehicle that is trailing the vehicle 10. Any vehicle that is in the center of the same lane, an adjacent lane or another lane, either ahead, behind or along side of the vehicle 10, can be a leading-vehicle. The term leading-vehicle is not referring to the leading-vehicle position but rather that the vehicle 10 is following the ‘lead’ (the direction or position) of the leading-vehicle.

Confidence information is data regarding the reliability of the estimated lane. Confidence information can be in the form of a percent estimate of reliability, or any other information that helps improve the understanding of the context of the estimated lane such that an improved detected lane can be produced. For example, confidence information of the leading-vehicle estimated lane would include whether the leading-vehicle is changing lanes. For the lane-marker estimated lane confidence information would include how much of the lane markers could be seen on each edge of the lane.

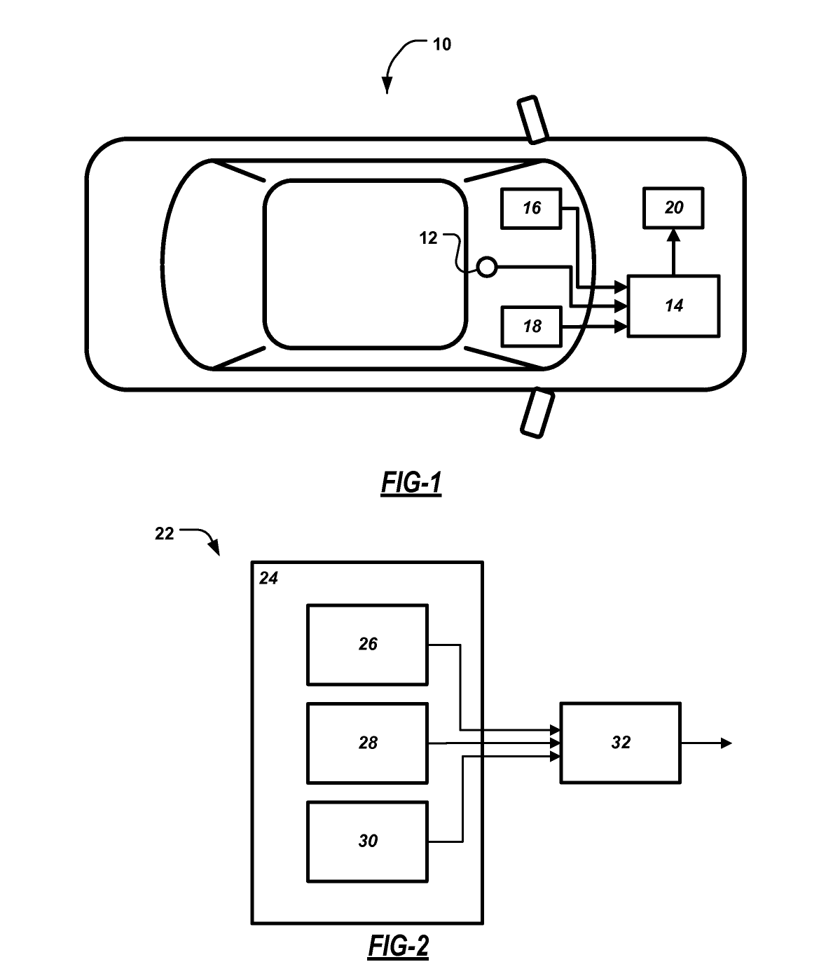

FIG. 2 is a block diagram of a lane detection sub-system 22 that can be part of the lane centering system 14. The lane detection sub-system 22 includes a lane estimating sub-system 24 that detects, or senses, the lane using various processors that process the sensor data. In this embodiment, the lane estimating sub-system 24 includes three lane detection processors: a lane-marker processor 26, a leading-vehicle processor 28, and a GPS and Map processor 30. The processors 26, 28 and 30 in the lane estimating sub-system 24 process sensor data and provide estimated lanes and corresponding confidence information to a combining processor 32. The lane-marker processor 26 detects and provides a lane-marker estimated lane and lane-marker confidence information. The leading-vehicle processor 28 identifies and tracks a leading-vehicle estimated lane and leading-vehicle confidence information. The GPS and Map processor 30 detects and provides a GPS/Map estimated lane and GPS/Map confidence information. For example, if the leading-vehicle—used to detect a leading-vehicle estimated lane—is changing lanes, then the leading-vehicle confidence information would indicate the lane change and may indicate that there is low confidence in the leading-vehicle estimated lane. The combining processor 32 utilizes the estimated lanes and confidence information along with additional vehicle/road information to determine a detected lane. For example, the combining processor 32 can ignore the leading-vehicle lane if the leading-vehicle confidence information indicates low confidence because the leading-vehicle is changing lanes. Once the combining processor 32 has produced a detected lane, the detected lane can be provided to other parts of the lane centering system 14 for calculating things such as steering adjustments.

The combining processor 32 can combine the information from the various estimated lanes based on the confidence information to determine the detected lane. As mentioned previously, the combining processor 32 can ignore the leading-vehicle estimated lane if the leading-vehicle confidence information indicates low confidence because the leading-vehicle is changing lanes. If, on the other hand, the leading-vehicle confidence information indicates high confidence and the lane-marker confidence information indicates low confidence, because no lane-markers are visible, then the combining processor 32 can provide the detected lane based mainly on the leading-vehicle estimated lane.

The combining processor 32 can determine the detected lane by using confidence weights. The combining processor 32 can assign weight factors to the estimated lanes based on the confidence information. Low confidence estimated lanes get low weight factors, and high confidence estimated lanes get high weight factors. The detected lane can be based on the assigned weight factors, with the highest weight factor estimated lanes having the biggest influence on the detected lane. For example, the detected lane could be a weighted geometric average of the estimated lanes.

The combining processor 32 can also adjust the confidence in an estimated lane based on combining information about the estimated lanes. For example, if the combining processor 32 notices the leading-vehicle is moving progressively away from a lane-marker estimated lane center, then the leading-vehicle may be executing a non-signaled lane change and the confidence in the leading-vehicle estimated lane can be reduced. Similarly, if weight factors are being used, the weight factors could be similarly adjusted downwards.

Other processors for processing sensor data can also be provided to produce an estimated lane, such as laser range finders (LIDAR), V2V communication, or any other processor that produces an estimated lane.

The lane detection processors 26 and 28 will reasonably assume that the highway is straight for purposes of detecting the lane in a short distance. It is reasonable to assume that the highway is straight because the tightest curve on a highway is a 500 meter radius curve which would result in a 20 centimeter error from the lane estimate 10 meters ahead of the vehicle. An error of 20 centimeters at 10 meters ahead of the vehicle 10 is not a significant factor in steering the vehicle 10 in lane that is typically 4 meters wide.

Examples for the lane-marker processor 26 can be found in U.S. patent application Ser. No. 12/175,631, filed Mar. 6, 2009, titled “Camera-Based Lane-marker Detection,” assigned to the assignee of this application and herein incorporated by reference, which discloses an exemplary system for this purpose, and U.S. patent application Ser. No. 13/156,974 (herein referred to as '974) filed Jun. 9, 2011, titled “Lane Sensing through Lane Marker Identification for Lane Centering/Keeping,” assigned to the assignee of this application and herein incorporated by reference, which discloses a system and method for detecting the position of a vehicle in a roadway lane and centering the vehicle in the lane.

The detected lane along with the current location of the vehicle 10 in the detected lane is used to calculate steering adjustments by other sub-systems of the lane centering system 14 that are sent to the steering system 20 to make/keep the vehicle 10 in the lane-center. Examples of these calculations and steering adjustments are discussed in the '317 application and the '974 application.

The lane detection sub-system 22 uses various estimated lanes along with other information, such as other vehicle information and road information to construct a detected lane. Other vehicle information—such as the leading-vehicle and intent to change lanes—can help improve the accuracy of the estimated lane. Road information—such as the vehicle speed, vehicle orientation to the road, and knowledge of the road ahead—can help improve the accuracy of the lane estimate. For example, when the vehicle 10 is traveling at a high rate of speed, then the road is likely straight; when the vehicle 10 is aligned with the road, then the vehicle 10 is likely staying in the lane; and when the vehicle 10 is not aligned to the road the vehicle 10 might be changing lanes. If the road ahead is turning sharply, then the normal assumption that the road is straight might be unreasonable to use in determining the detected lane.

The lane centering system 14 can use the estimated lanes and confidence information to adjust the vehicle position to improve the accuracy or confidence of the upcoming detected lane. For example, if a view-blocking-vehicle, like a preceding leading-vehicle, gets too close to the vehicle 10, such that the camera 12 can no longer see the lane-markers (see discussion below), then the lane centering system 14 can instruct the vehicle 10 to slow down. For example, if the vehicle normally would follow behind the leading-vehicle by 2 or 3 meters, then the lane centering system would want to increase the gap. The lane centering system 14 can detect a view-blocking-vehicle using devices other than the image, for example, information from a laser range finder. Many techniques about how to instruct the vehicle 10 to slow down would be well known by a person of ordinary skill in the art. Once the vehicle 10 slows, the distance to the view-blocking-vehicle will increase and render the lane-markers visible again, such that the lane-marker estimated lane will have more accuracy or higher confidence. In another example, snow may intermittently obscure the lane markers and there may be another vehicle that is consistently visible, but the other-vehicle is in a different highway lane. In this example, the lane centering system 14 can position the vehicle 10 by instructing the vehicle 10 to steer into the other lane with the other vehicle so that the lane centering system 14 will have the consistent leading-vehicle and the intermittent lane-marker estimated lanes to help provide an accurate detected lane.

The view-blocking-vehicle is described as an other vehicle that is ahead of the vehicle 10, but a view-blocking-vehicle can also be an other-vehicle that is trailing the vehicle 10, but is likewise blocking the view of the lane markers of a rear facing camera. In the case of a trailing view-blocking-vehicle, the vehicle 10 could be instructed to speed up until the distance is increased so that the lane markers are visible again.

FIG. 3 is a block diagram of a leading-vehicle processor 34 that shows one possible, but non-limiting, implementation of the leading-vehicle processor 28 that uses lane estimation by tracking lead-vehicle techniques. An image receiver 36, representing the camera 12, provides images to a vehicle detection module 38 and a lane-change detection processor 42. The vehicle detection module 38 identifies other vehicles in the images. The other vehicles are provided to a leading vehicle detection module 40 that identifies one or more leading-vehicles, if they exist. The leading-vehicle in this embodiment is another vehicle that is in the lane of vehicle 10 or an adjacent or other lane. If the leading-vehicle exists, then the leading-vehicle detection module 40 provides the leading-vehicle to the lane-change detection processor 42. Also, a V2V communication system 44 provides V2V information about other vehicles changing lanes to the lane-change detection processor 42 that uses the information to see if the leading-vehicle is signaling a lane change. The lane-change detection processor 42 observers the images of the leading-vehicle over time and can detect any early change or late change indicators, see discussion below. Information about lane-change is provided as part of the leading-vehicle confidence information to the estimated lane information sender 46 that can then provide the estimated lane and confidence information to the combining processor 32.

Detecting the indications of a leading-vehicle lane change can be accomplished with either early change signs or late change signs. Early signs include V2V communication and turn-signal detection. Turn-signal detection can be accomplished with the detection, in the series of images, of flashing light, pattern matching or any other signal that tells other drivers that the leading-vehicle will be changing lanes. Late signs include vehicle orientation detection (side of leading-vehicle is visible) or more lane-markers on one side are visible. Where seeing the side of the vehicle 10 indicates that the leading-vehicle is no longer heading straight, it is changing lanes and that is why the side of the leading-vehicle is visible. Where having more lane-markers that are visible on one side, than the other side lane markers can indicate that the leading-vehicle is moving towards or is over a lane edge, again indicating that a lane-change is occurring.

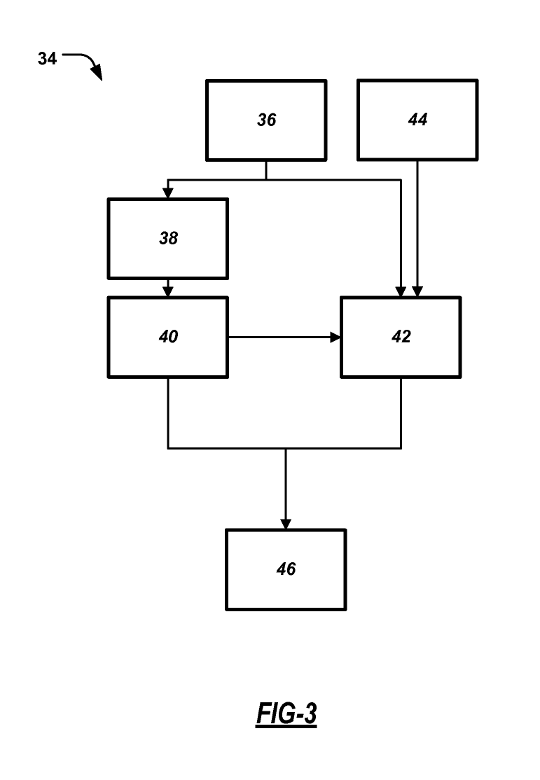

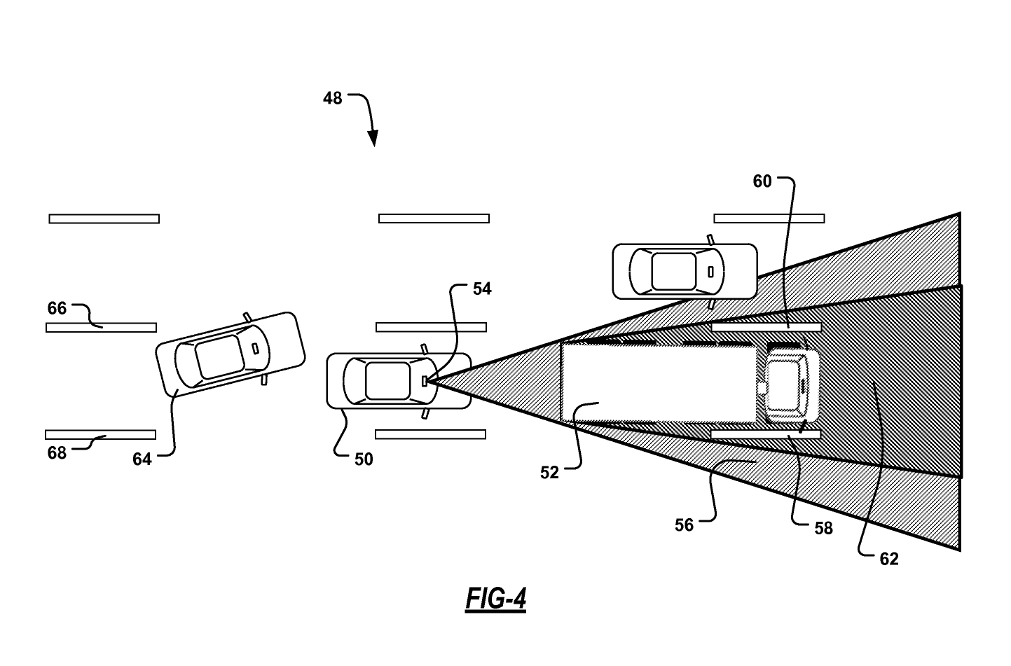

FIG. 4 is a illustration 48 showing an example of when a lane estimated by a leading-vehicle tracking method is needed to provide an accurate detected lane because a leading-vehicle hides the lane-markers from view. A vehicle 50 is traveling on the roadway following a leading vehicle 52. The vehicle 50 is equipped both with a front facing lane camera 54 and a rear-facing camera (not shown). The front facing lane camera 54 has a field of vision 56 that includes lane-markers 58 and 60, but the markers 58 and 60 are not visible to the front facing lane camera 54 because they are blocked by the leading vehicle 52 as indicated by blocked field of vision 62. The rear-facing camera does not have a clear view of rear lane-markers 66 and 68 because a trailing vehicle 64 blocks them. Also, the rear-facing camera fails to detect the rear-vehicle because it is not in the lane. In this situation, it is better to use the leading-vehicle estimated lane based on the leading vehicle 52 then to estimate the lane based on the lane-marker estimated lane.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A vehicle lane detection system for detecting a lane in a roadway which a vehicle is traveling, said system comprising:
a sensor mounted to the vehicle that provides sensor data including lane information;
a plurality of lane detection processors that process the sensor data and separately generate an estimated lane and confidence information, where the confidence information identifies a reliability of the estimated lane; and
a combining processor that combines the estimated lanes from each processor using the confidence information to determine the detected lane.

2. The system of claim 1 wherein the combining processor combines the estimated lanes by applying a confidence number to each estimated lane based on the confidence information and uses the estimated lane with the highest confidence number as the detected lane.

3. The system of claim 1 wherein the combining processor combines the estimated lanes by applying a weighting factor to each estimated lane based on the confidence information and determines the detected lane by having the highest weighted estimated lanes having the biggest influence on the detected lane.

4. The system of claim 1 wherein the sensor is a camera mounted to the vehicle that provides an image of the roadway, and wherein one of the lane detection processors is a leading-vehicle processor that processes the image to identify a leading-vehicle, where the leading-vehicle is another vehicle on the roadway and the leading-vehicle processor provides a leading-vehicle estimated lane and leading-vehicle confidence information.

5. The system of claim 4 wherein the leading-vehicle processor includes:
an image receiver that receives an image of the roadway:
a leading-vehicle processor that detects other vehicles in the image and identifies the leading-vehicle and the other-vehicles;
a lane-change detection processor that detects whether the leading-vehicle is changing lanes; and
an estimated lane information sender that provides information about the leading-vehicle estimated lane and leading-vehicle confidence information, wherein the leading-vehicle confidence information includes whether the leading-vehicle is changing lanes.

6. The system of claim 4 wherein the leading-vehicle confidence information also includes whether the leading-vehicle is changing lanes and the leading-vehicle processor identifies whether the leading-vehicle is changing lanes by identifying the lane change from a sequence of images, where the sequence of images is the image over time.

7. The system of claim 6 wherein the lane-change processor detects that the leading-vehicle is signaling a lane change with a vehicle turn-signal.

8. The system of claim 6 wherein the lane-change processor detects that the leading-vehicle is changing lanes because the side of the leading-vehicle is more visible or because more of the lane-markers are visible on one side of the lane than the other side of the lane.

9. The system of claim 4 wherein the leading-vehicle confidence information includes whether the leading-vehicle is changing lanes and the leading-vehicle processor determines if the leading-vehicle is changing lanes from information received through Vehicle-to-Vehicle communications.

10. The system of claim 4 wherein one of the lane detection processors is a lane-marker processor that identifies lane-markers in the image and based on the lane-markers provides a lane-marker estimated lane and lane-marker confidence information, and wherein the lane-marker estimated lane and the leading-vehicle estimated lane are used to determine the detected lane.

11. The system of claim 1 wherein the vehicle also uses sensor data or estimated lane and confidence information to adjust a position of the vehicle so that the sensor data will provide more accurate estimated lanes or increase confidence in the estimated lanes.

12. The system of claim 11 wherein the sensor is a camera mounted to the vehicle that provides an image of the roadway and wherein one of the lane detection processors is a lane-marker processor that identifies lane-markers in the image and based on the lane-markers provides a lane-marker estimated lane and lane-marker confidence information, and wherein the combining processor detects a view-blocking-vehicle that is blocking the view of the lane-markers, and wherein the combining processor adjusts the vehicle speed so the distance to the view-blocking-vehicle is enlarged so that the lane-markers can be seen in the image.

13. A vehicle lane detection system for detecting a lane in a roadway which a vehicle is traveling, said system comprising:
a sensor mounted to the vehicle that provides sensor data including lane information;
a plurality of lane detection processors that process the sensor data where each processor separately generates a estimated lane and confidence information and where the confidence information identifies a reliability of the estimated lane; and
a combining processor that adjusts a position of the vehicle so that the upcoming estimated lane and confidence information will be more accurate or have more confidence.

14. The system of claim 13 wherein the sensor is a camera mounted to the vehicle that provides an image of the roadway and wherein one of the lane detection processors is a lane-marker processor that identifies lane-markers in the image and based on the lane-markers provides a lane-marker estimated lane and lane-marker confidence information, and wherein the combining processor detects a view-blocking-vehicle that is blocking the view of the lane-markers, and wherein the combining processor adjusts the vehicle speed so that the distance to the view-blocking-vehicle is enlarged so that the lane-markers can be seen in the image.

15. The system of claim 13 wherein the combining processor combines the estimated lanes by applying a weighting factor to each estimated lane based on the confidence information and determines the detected lane by having the highest weighted estimated lanes have the most influence on the detected lane.

16. The system of claim 13 wherein the sensor is a camera mounted to the vehicle that provides an image of the roadway, and wherein one of the lane detection processors is a leading-vehicle processor that processes the image to identify a leading-vehicle that is another vehicle centered in a lane or centered on the vehicle wherein the leading-vehicle processor provides a leading-vehicle estimated lane and leading-vehicle confidence information, wherein the confidence information includes whether the leading-vehicle is changing lanes, and wherein the combining processor combines the estimated lanes to determine a detected lane based on the confidence information.

17. The system of claim 16 wherein the leading-vehicle processor identifies whether the leading-vehicle is changing lanes.

18. The system of claim 16 wherein the leading-vehicle confidence information includes whether the leading-vehicle is changing lanes and the leading-vehicle processor determines if the leading-vehicle is changing lanes from information received through Vehicle-to-Vehicle communications.

19. The system of claim 13 wherein one of the lane detection sub-system is a lane-marker processor that identifies lane-markers in the image and based on the lane-markers provides a lane-marker estimated lane and confidence information.

20. A process for detecting a lane in a roadway which a vehicle is traveling, said process comprising:
receiving sensor data including lane information;
processing the sensor data to calculate multiple estimated lanes and corresponding confidence information; and
determining a detected lane from the estimated lanes based on the confidence information.
